(19) United States
(12) Patent Application Publication
(10) Pub. No.: US 2015/0273357 A1
(43) Pub. Date: Oct. 1, 2015

(54) LIQUID ACCOMMODATION CONTAINER MANUFACTURING METHOD AND LIQUID ACCOMMODATION CONTAINER MANUFACTURING APPARATUS

(71) Applicant: SEIKO EPSON CORPORATION, Tokyo (JP)

(72) Inventor: Toshihiro YOKOZAWA, Shiojiri-shi (JP)

(21) Appl. No.: 14/663,089

(22) Filed: Mar. 19, 2015

(30) Foreign Application Priority Data
Mar. 26, 2014 (JP) 2014-063658
Mar. 26, 2014 (JP) 2014-063659

(51) Int. Cl. B01D 19/00

(52) U.S. Cl. CPC B01D 19/0036

(57) ABSTRACT

Provided is a liquid accommodation container manufacturing method which includes pre-pouring liquid from a storage portion for storing the liquid to a container for accommodating the liquid through a first piping portion, recovering the liquid from the container to the storage portion, and main-pouring the recovered liquid to the container through the first piping portion. Furthermore, the first piping portion has a degasification unit which communicates with the first piping portion and performs degasification of the liquid flowing therethrough. In addition, in at least a part of the pre-pouring and the main-pouring, a liquid feeding operation in which the liquid of the amount equal to or less than the capacity of the degasification unit is fed and a stop operation in which feeding of the liquid is stopped are alternately repeated and the liquid is subjected to degasification by the degasification unit.

### BACKGROUND

1. Technical Field

The present invention relates to a liquid accommodation container manufacturing method and a liquid accommodation container manufacturing apparatus.

2. Related Art

Hitherto, a liquid droplet discharge apparatus in which liquid droplets of ink are discharged through a plurality of nozzles in a liquid-droplet discharge head while a substrate and the liquid-droplet discharge head relatively move, in such a manner that the ink is disposed on a film forming surface of the substrate, is known. In such an apparatus, ink as liquid is accommodated in a pack-shaped container which is referred to as an “ink back” and formed of a film material having gas barrier properties and the ink is appropriately discharged from the container, in such a manner that the ink is used.

When ink is accommodated in such a container, there is a concern that the quality of the ink accommodated in the container may be deteriorated. Such a deterioration of ink occurs due to various causes, such as oxidation deterioration resulting from an operation at the time of pouring the ink and mixed-in foreign matter. As a result, a technique enabling the quality of accommodated ink to be maintained has been required and developed (see JP-A-2014-4806, for example).

Pouring of ink to a container is generally performed in a liquid accommodation container manufacturing apparatus having piping equipment. In such a manufacturing apparatus, to prevent oxidation deterioration of ink, oxygen dissolved in the ink is removed under a decompressed condition, prior to accommodation of the ink, in such a manner that the amount of dissolved oxygen is reduced to be equal to or less than a reference value. Hereinafter, such a reduction of oxygen dissolved in ink may be referred to as “degasification” or a “degasification treatment”.

When, in the manufacturing apparatus, such a degasification treatment and an ink pouring operation are performed at the same time, to prevent deterioration of the ink, it is necessary to perform an adequate degasification treatment enabling the dissolved oxygen concentration of the ink to be equal to or less than a reference value. The ink may flow through, for example, degasification equipment which is connected, in a communicating manner, with a piping portion for feeding the ink, in such a manner that the degasification treatment of ink is performed. In this case, to enable the dissolved oxygen concentration of the ink to be equal to or less than the reference value, it is necessary to ensure an adequate time for the ink staying in the degasification equipment.

However, when the time for the ink staying in such degasification equipment varies, variation in the dissolved oxygen concentration of ink is easily caused by the degasification treatment of ink in the degasification equipment. As a result, it is difficult to ensure a sufficient degasification performance.

The ink pouring operation performed in the manufacturing apparatus requires a reduction in the amount of waste ink. When the degasification equipment described above is used, the amount of waste ink can be reduced by applying not degasification equipment having a large capacity (which is in the range of 300 ml to 1000 ml) but degasification equipment having a small capacity (which is in the range of 10 ml to 30 ml).

However, in a case where such degasification equipment having a small capacity is used, when a time for the ink staying in the degasification equipment is ensured to enable the dissolved oxygen concentration of ink to be equal to or smaller than the reference value, it is necessary for the ink to flow by an extremely small amount. Such an ink flow-rate control is easily and greatly influenced by change in the pressure loss in a piping portion, and thus it is difficult to stably feed liquid. Accordingly, the time for the ink staying in the degasification equipment easily varies, and thus variation in the dissolved oxygen concentration of ink is likely to occur.

Furthermore, to ensure productivity, an ink filling operation performed in the manufacturing apparatus requires prevention of a reduction in the productivity, which results from the degasification treatment of ink.

However, the velocity of ink flowing in a piping portion greatly affects the ink filling speed. Accordingly, when a sufficient degasification performance is ensured in the degasification treatment of ink, the manufacturing time of a liquid accommodation container is likely to be extended.

### SUMMARY

An advantage of some aspects of the invention is to provide a liquid accommodation container manufacturing method in which an adequate degasification treatment is reliably performed and the amount of waste ink is reduced and a liquid accommodation container manufacturing apparatus in which a reduction in productivity is prevented.

The invention can be realized in the following forms or application examples.

### Application Example 1

According to this application example, there is provided a liquid accommodation container manufacturing method which includes pre-pouring liquid from a storage portion for storing the liquid to a container for accommodating the liquid through a first piping portion, recovering the liquid from the container to the storage portion, and main-pouring the recovered liquid to the container through the first piping portion. Furthermore, the first piping portion has a degasification unit which communicates with the first piping portion and performs degasification of the liquid flowing therethrough. In addition, in at least a part of the pre-pouring and the main-pouring, a liquid feeding operation in which the liquid of the amount equal to or less than the capacity of the degasification unit is fed and a stop operation in which feeding of the liquid is stopped are alternately repeated and the liquid is subjected to degasification by the degasification unit.

In this method, the liquid is poured into the container, in a state where the liquid feeding operation and the stop operation are alternately repeated in such a manner that degasification of the liquid is performed. Accordingly, it is possible to reliably perform degasification. Furthermore, in the pre-pouring, the container is filled with the liquid, in such a manner that the first piping portion is filled with the liquid. Then, the liquid in the container is recovered once. Thus, it is possible to reduce the amount of waste liquid. As a result, according to the method described above, it is possible to provide a liquid accommodation container manufacturing method in which an adequate degasification treatment is reliably performed and the amount of waste ink is reduced.

### Application Example 2

In the liquid accommodation container manufacturing method according to the application example, the degasification unit includes a first degasification module and a second degasification module which are connected in parallel in the first piping portion. Furthermore, the pre-pouring and the main-pouring are performed through the first degasification module and the second degasification module.

In this method, a plurality of degasification modules are provided, and thus the degasification treatment is efficiently performed. As a result, it is possible to improve the manufacturing efficiency of a liquid accommodation container.

### Application Example 3

In the liquid accommodation container manufacturing method according to the application example, in the pre-pouring and the main-pouring, the liquid feeding operation and the stop operation are alternately repeated with respect to the first degasification module and the second degasification module, the liquid is fed to the second degasification module while feeding of the liquid to the first degasification module stops, and the liquid is subjected to degasification.

In this method, in the entirety of both the first degasification module and the second degasification module, it is possible to reduce a time in which the liquid is not poured into the container. Accordingly, the amount of poured liquid for each unit time is increased. As a result, it is possible to improve production efficiency.

### Application Example 4

In the liquid accommodation container manufacturing method according to the application example, in the pre-pouring and the main-pouring, the liquid feeding operation and the stop operation are alternately repeated with respect to the first degasification module and the second degasification module, and the liquid is fed to the first degasification module and the second degasification module at the same time.

In this method, the amount of poured liquid for each unit time in a liquid feeding period is increased. As a result, it is possible to improve production efficiency.

### Application Example 5

In the liquid accommodation container manufacturing method according to the application example, the storage portion has a first container and a second container which are connected in parallel in the first piping portion and accommodates the liquid. Furthermore, in the main-pouring, the liquid is poured into the first container and the second container at the same time.

In this method, a plurality of liquid accommodation containers can be manufactured at the same time.

### Application Example 6

In the liquid accommodation container manufacturing method according to the application example, the storage portion has a first container and a second container which are connected in parallel in the first piping portion and accommodates the liquid. Furthermore, in the main-pouring, the liquid is poured alternately into the first container and the second container.

In this method, a plurality of liquid accommodation containers can be manufactured at the same time.

### Application Example 7

In the liquid accommodation container manufacturing method according to the application example, in the main-pouring, the inner portion of the storage portion is pressurized and the liquid is pressure-fed using the pressure difference between the storage portion and the container.

In this method, the entirety of the liquid in the first piping portion can be poured. As a result, it is possible to reduce the amount of waste liquid.

### Application Example 8

In the liquid accommodation container manufacturing method according to the application example, in the recovering, the liquid is recovered through a second piping portion connecting the storage portion and the container.

In a case where a common piping portion is used in the pre-pouring, the main-pouring, and the recovering, even when the first piping portion is filled with the liquid which is subjected to degasification during the pre-pouring or the main-pouring, the liquid subjected to degasification is also recovered during the recovering. Accordingly, even when a part of liquid should be poured into the container, the part of liquid is unnecessarily subjected to a degasification operation again. As a result, unnecessary work is caused. However, in a case where a piping portion used in the pre-pouring and the main-pouring and a piping portion used in the recovering differ from each other, unnecessary work as described above is prevented from being caused. As a result, it is possible to effectively manufacture a liquid accommodation container.

### Application Example 9

In the liquid accommodation container manufacturing method according to the application example, in the recovering, the inner portion of the storage portion is depressurized and the liquid is recovered using the pressure difference between the storage portion and the container.

In this method, the liquid can be recovered without remaining liquid in the second piping portion, and thus it is possible to reduce the amount of waste liquid. As a result, waste of liquid is prevented.

### Application Example 10

In the liquid accommodation container manufacturing method according to the application example, the storage portion has a first storage portion and a second storage portion which are connected in parallel in the first piping portion. Furthermore, when the pre-pouring or the main-pouring is performed in the first storage portion, the inner portion of the second storage portion is depressurized.

In this method, for example, preparation for the recovering is performed by depressurizing the second storage portion while the pre-pouring is performed in the first storage portion. Accordingly, the recovering can be performed immediately after the pre-pouring is finished. Thus, it is possible to reduce a time in which manufacturing of a liquid accommodation container is not performed. As a result, it is possible to improve work efficiency.

### Application Example 11

In the liquid accommodation container manufacturing method according to the application example, a bypass piping portion which bypasses the degasification unit is connected to the first piping portion. Furthermore, in the pre-pouring, the liquid is poured from the storage portion to the container through the bypass piping portion.

In this method, it is possible to reduce the time of the pre-pouring. As a result, it is possible to improve manufacturing efficiency.

### Application Example 12

In the liquid accommodation container manufacturing method according to the application example, in the pre-pouring, the liquid is poured from the storage portion to the container through the bypass piping portion, then the liquid is poured into the container via the degasification unit, in such a manner that a part of the first piping portion, which is the portion extending from the degasification unit to the container, is filled with the liquid subjected to degasification.

In this method, when the main-pouring starts, the liquid filled in a part of the first piping portion, which is the portion extending from the degasification unit to the container, can be poured into the container, without performing an additional degasification treatment. As a result, it is possible to reduce an operation time.

### Application Example 13

In the liquid accommodation container manufacturing method according to the application example, in at least the main-pouring, a foreign-matter removing operation is performed to remove foreign matter mixed in the liquid.

In this method, it is possible to manufacture a liquid accommodation container having liquid of high quality.

### Application Example 14

In the liquid accommodation container manufacturing method according to the application example, the foreign-matter removing operation is performed further on the storage portion side in the first piping portion than the degasification unit.

In this method, foreign matter is removed from the liquid flowing to the degasification unit. As a result, the efficiency of a degasification operation is improved in the degasification unit.

### Application Example 15

According to this application example, there is provided a liquid accommodation container manufacturing apparatus which includes a first piping portion which connects a storage portion for storing liquid and a container for accommodating the liquid, a first degasification module and a second degasification module which are connected in parallel in a state where the first degasification module and the second degasification module communicate with the first piping portion and which perform degasification of the liquid flowing therethrough, the first degasification module and the second degasification module being provided in a path of the first piping portion, and a pouring-amount control portion which is disposed further on the storage portion side in the first piping portion than the first degasification module and the second degasification module and controls the amount of liquid poured into the first degasification module and the second degasification module.

In this configuration, when liquid is poured into the first degasification module and the second degasification module, the amount of poured liquid can be controlled. Accordingly, it is difficult for variation in degasification treatment to occur in each degasification module, and thus the degasification treatment with stable quality can be performed using a plurality of degasification modules. Furthermore, the plurality of degasification modules can be used in combination, and thus the amount of degasification-treatable liquid is increased for each unit time. Therefore, even when an adequate degasification treatment is performed in each degasification module, it is possible to prevent productivity from being reduced. Thus, according to the liquid accommodation container manufacturing apparatus having the configuration described above, it is possible to provide a liquid accommodation container manufacturing apparatus in which an adequate degasification treatment can be performed while preventing a reduction in productivity.

### Application Example 16

In the liquid accommodation container manufacturing apparatus according to the application example, the pouring-amount control portion includes a branch pipe which branches the first piping portion into a path directed to the first degasification module and a path directed to the second degasification module, a valve which is provided in a piping path extending in a portion between the branch pipe and the first degasification module, and a valve which is provided in a piping path extending in a portion between the branch pipe and the second degasification module.

In this configuration, even when the first degasification module and the second degasification module have different configurations, the same amount of liquid can be fed to the degasification modules by operating the valves. As a result, the degasification treatment can be performed in each degasification module without variation in the degasification treatment.

### Application Example 17

In the liquid accommodation container manufacturing apparatus according to the application example, the pouring-amount control portion includes a branch pipe which branches the first piping portion into a path directed to the first degasification module and a path directed to the second degasification module, a piping portion which connects the branch pipe and the first degasification module, and a piping portion which connects the branch pipe and the second degasification module. Furthermore, the piping portion connecting the branch pipe and the first degasification module and the piping portion connecting the branch pipe and the second degasification module have the same pressure loss.

In this configuration, when the liquid is poured into the first degasification module and the second degasification module, the pouring pressures are the same. Accordingly, variation in the flow speed of the liquid flowing into each degasification module is prevented from occurring. Thus, it is easy to feed the liquid to the respective degasification modules by the same amount. Therefore, it is difficult for variation in the degasification treatment in each degasification module to occur. As a result, the degasification treatment with stable quality can be performed using the plurality of degasification modules.

### Application Example 18

In the liquid accommodation container manufacturing apparatus according to the application example, the piping portion connecting the branch pipe and the first degasification module and the piping portion connecting the branch pipe and the second degasification module have the same length.

In this configuration, the pressure losses in piping portions can be easily set to be the same.

### Application Example 19

In the liquid accommodation container manufacturing apparatus according to the application example, the first degasification module and the second degasification module are disposed at positions equidistant from the branch pipe.

In this configuration, the pressure losses in piping portions can be easily set to be the same.

### Application Example 20

In the liquid accommodation container manufacturing apparatus according to the application example, a liquid accommodation container manufacturing apparatus further includes a foreign-matter removing unit which removes foreign matter mixed in the liquid and is disposed further on the storage portion side in the first piping portion than the pouring-amount control portion.

In this configuration, in the pouring-amount control portion, the foreign matter in the liquid can be removed at a position in front of a portion in which the first piping portion is branched. Thus, it is possible to efficiently manufacture a liquid accommodation container having a liquid of high quality. Furthermore, foreign matter is removed from the liquid flowing into the degasification module. As a result, the efficiency of a degasification operation is improved in the degasification unit.

### BRIEF DESCRIPTION OF THE DRAWINGS

The invention will be described with reference to the accompanying drawings, wherein like numbers reference like elements.

FIG. 1 is a schematic diagram illustrating a liquid accommodation container manufacturing apparatus of an embodiment.

FIG. 2 is a schematic diagram of a first storage portion.

FIG. 3 is a schematic diagram of a foreign-matter removing portion.

FIG. 4 is a schematic diagram illustrating the configuration of a degasification module.

FIG. 5 is a schematic diagram of a first pouring portion.

FIG. 6 is an explanatory diagram of a degasification operation of the degasification module.

FIG. 7 is a diagram for explaining a degasification operation in a case where a plurality of the degasification modules are used.

FIG. 8 is a diagram for explaining a degasification operation in a case where a plurality of the degasification modules are used.

### DESCRIPTION OF EXEMPLARY EMBODIMENTS

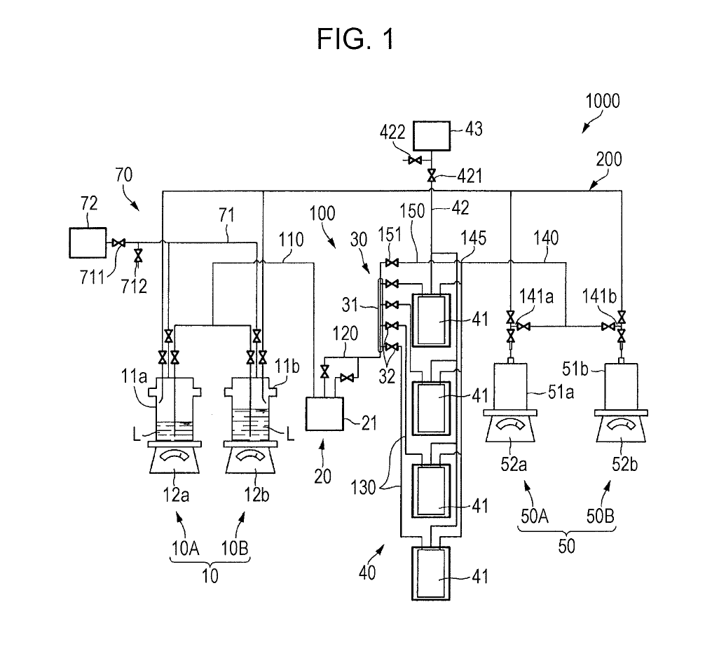

Hereinafter, a liquid accommodation container manufacturing method according to an embodiment of the invention will be described with reference to FIGS. 1 to 8. In the drawings referred to in the following description, the size and the proportion of each component is appropriately changed for clarity.

### Liquid Accommodation Container Manufacturing Apparatus

FIG. 1 is a schematic diagram illustrating a liquid accommodation container manufacturing apparatus 1000 which is used for performing the liquid accommodation container manufacturing method of this embodiment. It is possible to manufacture, for example, a liquid accommodation container in which a functional ink which is used for forming an organic layer of an organic EL element using a liquid-droplet discharge apparatus is accommodated or a color ink which is used for forming a color filter using a liquid-droplet discharge apparatus is accommodated, by the liquid accommodation container manufacturing method of this embodiment.

As illustrated in FIG. 1, the manufacturing apparatus 1000 has a storage portion 10 for storing a liquid (an ink) L and a pouring portion 50. The pouring portion 50 is used for pouring the ink L into containers 51a and 51b.

In this application, the containers 51a and 51b in which the ink L satisfying a predetermined quality is accommodated are referred to as a “liquid accommodation container” which is a manufacturing object. In other words, the liquid accommodation container includes the containers 51a and 51b and the ink L accommodated in the containers 51a and 51b.

The storage portion 10 and the pouring portion 50 are connected through a first piping portion 100 and a second piping portion 200. A foreign-matter removing portion (in other words, a foreign-matter removing unit) 20, a branching portion (in other words, a pouring-amount control portion) 30, and a degasification portion 40 are connected to the path of the first piping portion 100, in order from the storage portion 10 side. In addition, the first piping portion 100 has a piping portion 110, a piping portion 120, a piping portion 130, and a piping portion 140. The piping portion 110 connects the storage portion 10 and the foreign-matter removing portion 20. The piping portion 120 connects the foreign-matter removing portion 20 and the branching portion 30. The piping portion 130 connects the branching portion 30 and the degasification portion 40. The piping portion 140 connects the degasification portion 40 and the pouring portion 50.

A pressure adjustment portion 70 is connected to the storage portion 10. The pressure adjustment portion 70 pressurizes or depressurizes the inner portion of the storage portion 10. The pressure adjustment portion 70 has a piping portion 71 and a vacuum pump 72. The vacuum pump 72 is connected to one end of the piping portion 71, via a valve 711 interposed therebetween. A part of the piping portion 71 is branched and the branched part is connected to pressurizing equipment (not illustrated) via a valve 712 interposed therebetween. The pressurizing equipment supplies, for example, nitrogen (N₂).

Hereinafter, the descriptions will be given in order.

The storage portion 10 has a first storage portion 10A and a second storage portion 10B. The first storage portion 10A has a tank 11a for storing the ink L and a metering device 12a. The metering device 12a meters the mass of the tank 11a having the ink L stored therein. Similarly to the first storage portion 10A, the second storage portion 10B has a tank 11b and a metering device 12b.

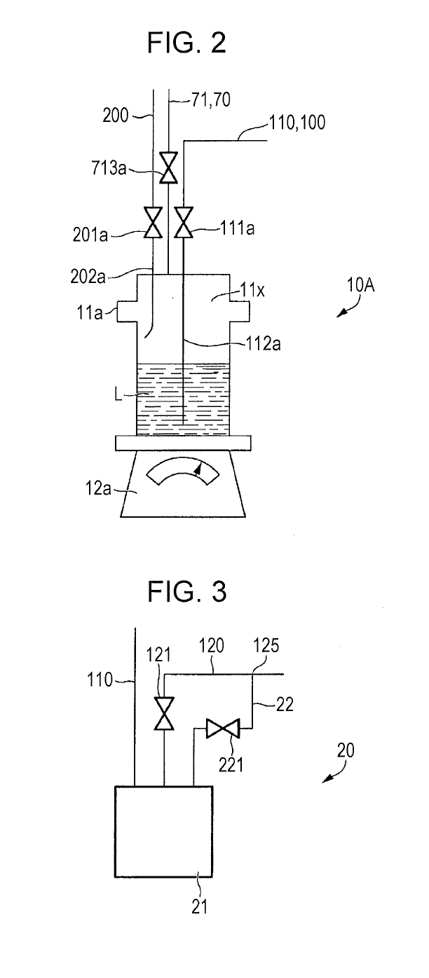

FIG. 2 is a schematic diagram of the first storage portion 10A. The piping portion 110 of the first piping portion 100, the second piping portion 200, and the piping portion 71 of the pressure adjustment portion 70 are connected to the tank 11a of the first storage portion 10A. The configuration of the second storage portion 10B is the same as that of the first storage portion 10A, and thus the description thereof will not be repeated.

A piping portion 112a is connected to the piping portion 110, via a valve 111a interposed therebetween. The tip of the piping portion 112a is immersed in the ink L stored in an internal space 11x of the tank 11a.

A piping portion 202a is connected to the second piping portion 200, via a valve 201a interposed therebetween. The piping portion 202a extends to the internal space 11x of the tank 11a.

The piping portion 71 is connected to the tank 11a, via a valve 713a interposed therebetween. The pressure adjustment portion 70 illustrated in FIG. 1 supplies, through the piping portion 71, nitrogen to the internal space 11x of the tank 11a, in such a manner that the pressure adjustment portion 70 pressurizes the internal space 11x. Furthermore, the pressure adjustment portion 70 depressurizes the internal space 11x of the tank 11a, through the piping portion 71.

Returning to FIG. 1, the storage portion 10 side of the piping portion 110 is branched into two piping portions. One of the two piping portions is connected to the first storage portion 10A and the other is connected to the second storage portion 10B. The end portion of the piping portion 110, which is located on the pouring portion 50 side, is connected to the foreign-matter removing portion 20.

FIG. 3 is a schematic diagram of the foreign-matter removing portion 20. The foreign-matter removing portion 20 has a filter body 21. The filter body 21 filters the ink L passing therethrough, in such a manner that the filter body 21 removes the foreign matter in the ink L. Furthermore, the piping portion 120 is connected to the filter body 21, via the valve 121.

The ink L flowing in the piping portion 110 passes through the filter body 21, and then is fed to the piping portion 120. Accordingly, the foreign matter in the ink L can be removed. A foreign-matter removing unit having a known configuration can be appropriately used as the foreign-matter removing portion 20, in accordance with the type of the ink L and the size of foreign matter as a removal target.

In addition, the foreign-matter removing portion 20 has a vent line 22. The vent line 22 connects the filter body 21 and the piping portion 120 and promotes emission of gas in the filter body 21. One end of the vent line 22 is connected to the filter body 21. Furthermore, in a connection portion 125, the other end of the vent line 22 is connected to the piping portion 120. The vent line 22 has a valve 221.

Returning to FIG. 1, the storage portion 10 side of the piping portion 120 is connected to the foreign-matter removing portion 20. Furthermore, the end portion of the piping portion 120, which is located on the pouring portion 50 side, is connected to the branching portion 30.

The branching portion 30 has branch pipes 31 which are branched along four directions and valves 32 which are provided in accordance with the four branching directions. The piping portions 130 are connected to the branching portion 30. Opening/closing of the valves 32 is separately controlled in the branching portion 30, in such a manner that the feeding target of the ink L flowing in the piping portion 120 can be selected among the piping portions 130.

The branching portion 30 (which are the branch pipes 31 and the valves 32) corresponds to the “pouring-amount control portion” of the invention.

In the manufacturing apparatus 1000 of this embodiment, the four piping portions 130 have the same internal diameter. Furthermore, the four piping portions 130 have the same length. When the piping portions 130 have the configuration as described above, it is easy to equally control the pressure losses in the four piping portions 130. Furthermore, even when the ink L flows to any one of the four piping portions 130, the internal pressures (in other words, the pouring pressures) of the inks L in the pouring portion 50 sides of the piping portions 130 are the same.

In the four piping portions 130, the internal diameter and the length of the piping portion or the inner-surface forming material of the piping portion may be appropriately changed as long as the pressure losses are the same.

The degasification portion 40 has the four degasification modules 41, the piping portion 42 connected to the four degasification modules 41, and a vacuum pump 43 which is connected to one end of the piping portion 42 via a valve 421 interposed therebetween. A part of the piping portion 42 is branched and an atmosphere releasing valve 422 is connected to the branched portion. The end portions of the four piping portions 130, which are located on the pouring portion 50 side, are respectively connected to the degasification modules 41 of the degasification portion 40.

The degasification portion 40 corresponds to a “degasification unit” of the invention. Two of four degasification modules 41 are a “first degasification module” and a “second degasification module” of the invention.

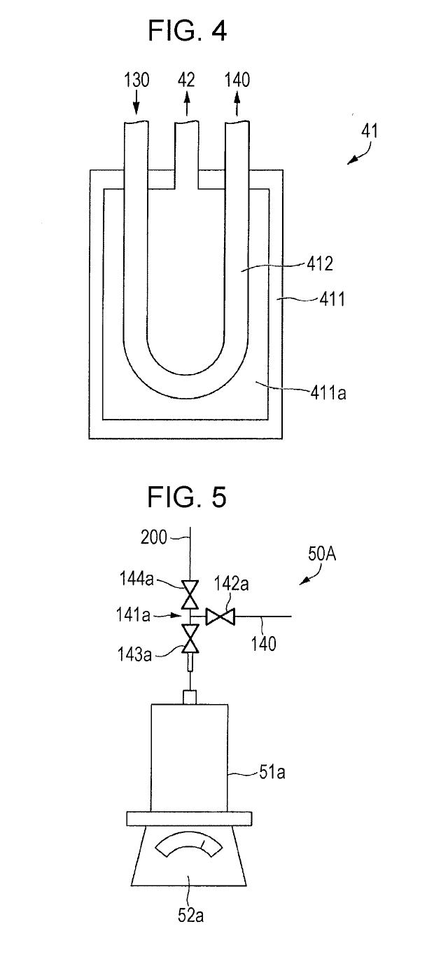

FIG. 4 is a schematic diagram illustrating the configuration of the degasification module 41. The degasification module 41 has a case body 411 having an internal space 411a and a pipe conduit 412. The pipe conduit 412 is installed in the case body 411. One end of the pipe conduit 412 is connected to the piping portion 130 and the other end is connected to the piping portion 140. Furthermore, a piping portion 42 is connected to the case body 411.

The pipe conduit 412 is constituted of a bundle of hollow fibers which are formed of material not allowing the ink L to pass therethrough but allowing gases, such as oxygen and nitrogen dissolved in the ink L, to pass therethrough. The volume of the pipe conduit 412 corresponds to the “volume of a degasification unit” of the invention.

When such a degasification module 41 is operated, first, the internal space 411a is depressurized by the vacuum pump 43 which is connected to the internal space 411a through the piping portion 42. Next, the ink L is fed to the pipe conduit 412, in a state where the internal space 411a is depressurized. Accordingly, gases such as, the oxygen and the nitrogen dissolved in the ink L flowing in the pipe conduit 412, are removed through the pipe wall of the pipe conduit 412.

In the degasification portion 40, the four degasification modules 41 are arranged in parallel. When viewed from top, the four degasification modules 41 are arranged radially, for example. The branching portion 30 is provided at the position equidistant from the four degasification modules 41.

The valves 32 of the branching portion 30 are switched, in such a manner that the four degasification modules 41 can be switched. The four degasification modules 41 may be operated at the same time. Alternatively, the four degasification modules 41 may be operated in order by switching the valves 32.

Returning to FIG. 1, the storage portion 10 side of the piping portion 140 is branched into four piping portions. The four branched piping portions are respectively connected to the degasification modules 41 of the degasification portion 40. The end portion of the piping portion 140, which is located on the pouring portion 50 side, is branched into two piping portions. One of the two branched piping portions is connected to the pouring portion 50 via a three-way valve 141a and the other is connected to the pouring portion 50 via a three-way valve 141b.

The piping portion 140 has a bypass piping portion 150. One end of the bypass piping portion 150 is connected to the branch pipe 31 of the branching portion 30 and the other end thereof is connected, in a connection portion 145, to the piping portion 140. The bypass piping portion 150 has a valve 151.

The pouring portion 50 has a first pouring portion 50A and a second pouring portion 50B. The first pouring portion 50A has a container 51a in which the ink L is poured and a metering device 52a which meters the mass of the container 51a having the ink L poured therein. Similarly to the first pouring portion 50A, the second pouring portion 50B has a container 51b and a metering device 52b.

FIG. 5 is a schematic diagram of the first pouring portion 50A. Both the piping portion 140 and the second piping portion 200 are connected to the container 51a of the first pouring portion 50A, via the three-way valve 141a interposed therebetween. The configuration of the second pouring portion 50B is the same as that of the first pouring portion 50A, and thus the description thereof will not be repeated.

The three-way valve 141a has valves 142a, 143a, and 144a. The valve 142a is connected to the piping portion 140, the valve 143a is connected to the container 51a, and the valve 144a is connected to the second piping portion 200.

Returning to FIG. 1, the storage portion 10 side of the second piping portion 200 is branched into two piping portions. One of the two branched piping portions is connected to the tank 11a of the first storage portion 10A and the other is connected to the tank 11b of the second storage portion 10B. Furthermore, the end portion of the second piping portion 200, which is located on the pouring portion 50 side, is branched into two piping portions. One of the two branched piping portions is connected to the pouring portion 50 via the three-way valve 141a interposed therebetween and the other is connected to the pouring portion 50 via the three-way valve 141b interposed therebetween.

The manufacturing apparatus 1000 used in the liquid accommodation container manufacturing method of this embodiment has the configuration as described above.

### Liquid Accommodation Container Manufacturing Method

Next, the liquid accommodation container manufacturing method with the liquid accommodation container manufacturing apparatus of this embodiment will be described. The liquid accommodation container manufacturing method of this embodiment includes a pre-pouring step, a recovery step, and a main-pouring step. In the pre-pouring step, the ink L from the storage portion 10 is poured into the containers 51a and 51b through the first piping portion 100. In the recovery step, the ink L is recovered from the containers 51a and 51b to the storage portion 10. In the main-pouring step, the recovered ink L is poured into the containers 51a and 51b through the first piping portion 100.

### Pre-Pouring Step

In the pre-pouring step, first, the inner portion of the tank 11a, for example, is pressurized by the pressure adjustment portion 70 and the valve 111a is opened, in such a manner that the ink L in the tank 11a is pressure-fed. The ink L reaches the foreign-matter removing portion 20 through the piping portion 110.

When the pre-pouring step is started, even when the ink L passes through the filter body 21 of the foreign-matter removing portion 20, it may be difficult for gases in a filter (not illustrated) of the filter body 21 to be released. In this case, first, the ink L is fed by causing the ink L to flow through the vent line 22, in such a manner that the inner portion of the filter body 21 is filled with the ink L. In the operation in which the ink L flows through the vent line 22, the filter in the filter body 21 is gradually soaked by the ink, and thus the gases in the filter are gradually emitted.

Subsequently, the ink L is fed to the vent line 22 side for a predetermined time. Then, the valve 221 is closed and the valve 121 is opened, in such a manner that the flow path of the ink L is switched. Accordingly, in the foreign-matter removing portion 20, it is easy to perform emission of gases in the filter.

In addition, the ink L reaches the branching portion 30 through the piping portion 120. In the branching portion 30, the ink L is fed to the four degasification modules 41 by opening the four valves 32 and the ink L is fed to the piping portion 140 through the bypass piping portion 150 by opening the valve 151. Upon comparison with the pipe conduit 412 of the degasification module 41, the pressure loss is relatively small in the bypass piping portion 150, and thus it is easy to feed the ink L. As a result, it is possible to perform pre-pouring of the ink L in a short time.

The ink L is fed from the connection portion 145 to the pouring portion 50 through the piping portion 140 and, further, the ink L is fed from the connection portion 145 to the degasification module 41 through the piping portion 140. Accordingly, the ink L is fed to the degasification module 41 through the piping portions 130 and 140, and thus the pipe conduit 412 is filled with the ink L in a short time.

When the pipe conduit 412 of the degasification module 41 is filled with the ink L, the valve 151 may be closed.

The ink L reaches the containers 51a and 51b of the pouring portion 50, through the piping portion 140. As a result, the ink L is poured into the containers 51a and 51b.

In the pre-pouring step, the ink L is fed in a state where the ink L is subjected to degasification by driving the degasification portion 40, in such a manner that the ink L filling the piping portion 140 extending from an outlet of the degasification module 41, which is located on the pouring portion 50 side, to inlets of the containers 51a and 51b is replaced by the ink L subjected to degasification. Thus, when the main-pouring step described below is started, the ink L in the piping portion 140 can be poured into the containers 51a and 51b without an additional degasification treatment. As a result, it is possible to reduce an operation time.

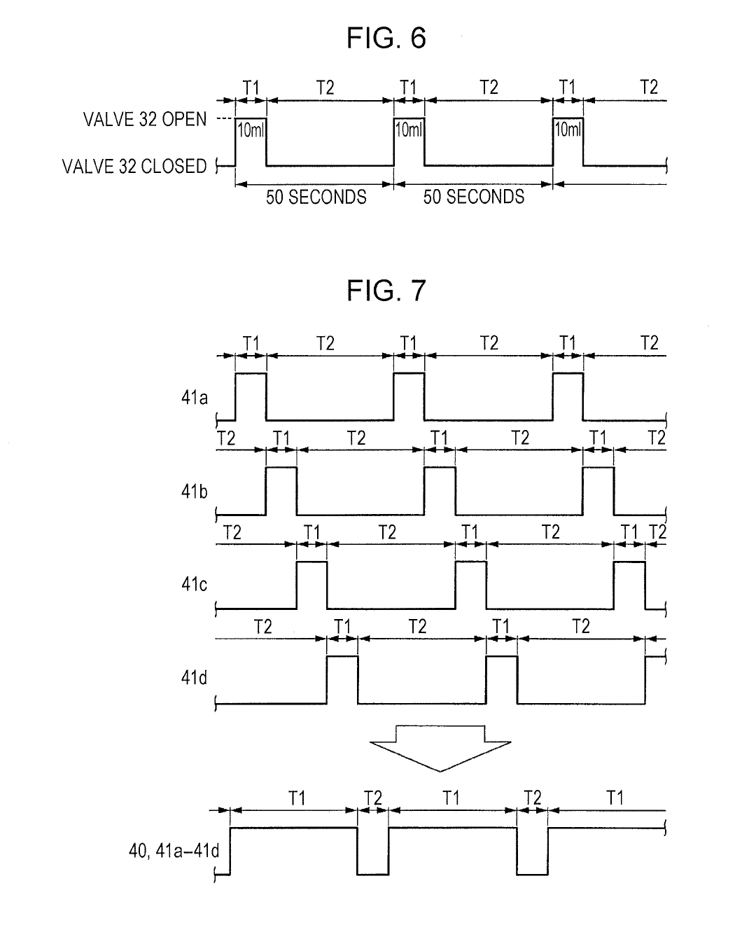

FIG. 6 is an explanatory diagram of the degasification operation in the degasification module 41. According to FIG. 6, in the degasification module 41, a degasification treatment time of 50 seconds is necessary for setting the dissolved oxygen concentration of the ink L to be equal to or less than a reference value. Furthermore, the capacity of the pipe conduit 412 of the degasification module 41 is 10 ml. The reference value of the dissolved oxygen concentration of the ink L is a value defined in accordance with the required quality of a product, such as an organic EL element and a color filter, manufactured by the ink L.

In the liquid accommodation container manufacturing method of this embodiment, when the degasification module 41 having the configuration described above is applied, a liquid feeding operation in which the ink L is fed by the amount equal to or less than the capacity of the degasification module 41 and a stop operation in which feeding of the ink L is stopped are alternately performed. In FIG. 6, a period in which the liquid feeding operation is performed is indicated by a reference letter and numeral T1 and a period in which the stop operation is performed is indicated by a reference letter and numeral T2. Switching between the liquid feeding operation and the stop operation is controlled by opening/closing the valve 32. According to FIG. 6, in the liquid feeding operation, the ink L of 10 ml is fed for each opening/closing operation of the valve 32.

The amount of the ink L fed in the liquid feeding operation may be controlled by the metering device 12a of the storage portion 10 or the metering devices 52a and 52b of the pouring portion 50. The amount of fed ink L can be calculated by the density and the metered mass of the ink L. Furthermore, a flow meter may be provided in the first piping portion 100 and the amount of fed ink L may be controlled by monitoring the value of the flow meter.

The sum of a period in which liquid feeding is performed and a period in which liquid feeding is stopped is equal to or longer than the degasification treatment time necessary in the degasification module 41. It is preferable that the sum of the period in which liquid feeding is performed and the period in which liquid feeding is stopped be equal to the degasification treatment time necessary in the degasification module 41. In FIG. 6, the sum of the period in which liquid feeding is performed and the period in which liquid feeding is stopped is 50 seconds by which the degasification treatment is performed.

Accordingly, in the degasification module 41, the ink L is reliably subjected to degasification. The degasification operation described above is performed in accordance with the capacity of the piping portion 140 until the entirety of the ink L in the piping portion 140 is replaced by the ink L subjected to degasification.

### Recovery Step

Next, in the recovery step, the inner portion of the tank 11a, for example, is depressurized by the pressure adjustment portion 70 and the valve 111a is opened. Accordingly, the ink L in the containers 51a and 51b is recovered, by the pressure difference between the tank 11a and the containers 51a and 51b, to the tank 11a through the second piping portion 200. The pouring portion 50 may have a mechanism (for example, a mechanism which applies an external pressure by squeezing the containers 51a and 51b) which appropriately assists a recovery operation of the ink L.

In the recovery step, foreign matter in the containers 51a and 51b are discharged along with the ink L, and then the foreign matter is transferred to the tank 11a. Accordingly, the inner portions of the containers 51a and 51b are cleaned.

### Main-Pouring Step

Subsequently, in the main-pouring step, similarly to the pre-pouring step, the inner portion of the tank 11a, for example, is pressurized by the pressure adjustment portion 70 and the valve 111a is opened, in such a manner that the ink L in the tank 11a is pressure-fed. The ink L reaches the foreign-matter removing portion 20 through the piping portion 110. Next, foreign matter in the ink L is removed in the foreign-matter removing portion 20 (in other words, the foreign-matter removing operation is performed on the ink L), and then the ink L reaches the degasification portion 40.

In the manufacturing apparatus 1000, the foreign-matter removing portion 20 is located further on the storage portion 10 side than the degasification portion 40, and thus foreign matter in the ink L flowing to the degasification portion 40 is removed. As a result, the efficiency of the degasification operation is increased in the degasification portion 40.

In the main-pouring step, the degasification operations are performed in a plurality of the degasification modules 41, by following the method (which is the method illustrated in FIG. 6) described above, and then the ink L is poured into the containers 51a and 51b.

FIG. 7 is a diagram for explaining a degasification operation in a case where a plurality of degasification modules 41 are used in the main-pouring step. In FIG. 7, the four degasification modules 41 of the manufacturing apparatus 1000 are indicated by reference numerals and letters 41a, 41b, 41c, and 41d. Similarly to in the case of FIG. 6, a period in which a liquid feeding operation is performed is indicated by the reference letter and numeral T1 and a period in which a stop operation is performed is indicated by the reference letter and numeral T2.

In the main-pouring step, the liquid feeding operations of the plurality of the degasification modules 41 are performed in a state where the liquid feeding operations do not temporarily overlap each other and the plurality of degasification modules 41 are operated in parallel, as illustrated in FIG. 7. Accordingly, the liquid feeding operations can be continuously performed in terms of the entirety (in other words, the degasification modules 41a to 41d) of the degasification portion 40. As a result, the pouring operation can be continuously performed.

A main pouring operation is performed as described above, and thus, in terms of the entirety of the degasification portion 40, it is possible to reduce the time (that is, the period T2 in which the stop operation is performed) in which the pouring operation is not performed on the containers 51a and 51b. As a result, the amount of poured ink for each unit time can be increased, and thus production efficiency can be improved.

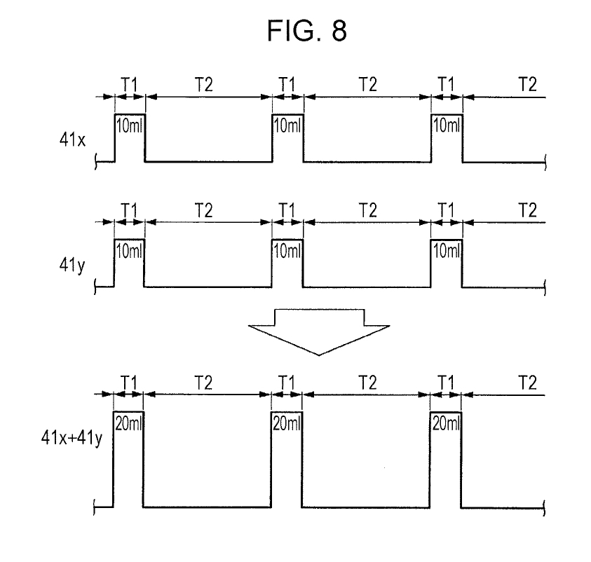

FIG. 8 is a diagram for explaining another example of the degasification operation in a case where the plurality of degasification modules 41 are used in the main-pouring step. In FIG. 8, reference numerals and letters 41x and 41y are given to two of the four degasification modules 41 of the manufacturing apparatus 1000.

In the main-pouring step, the liquid feeding operations of the plurality of degasification modules 41 may be performed in a state where the liquid feeding operations exactly temporally overlap each other and the plurality of degasification modules 41 may be performed in parallel, as illustrated in FIG. 8. However, in this case, it is necessary to set, in advance, the amounts of ink supplied to the respective degasification modules 41 during the liquid feeding operations, the setting pressures of the respective degasification modules 41, and the like such that the respective degasification modules 41 are in the same degasification state.

When the respective degasification modules 41 are in the same degasification state, it is possible to ensure the quality of the ink L which is subjected to degasification and is poured into the containers 51a and 51b. Thus, when liquid feeding is performed, the amount of poured ink for each unit time is increased from, for example, 10 ml to 20 ml, by using the plurality of degasification modules 41 at the same time, as illustrated in FIG. 8. As a result, production efficiency can be improved.

Needless to say, in the liquid accommodation container manufacturing method of this embodiment, the degasification operations illustrated in FIGS. 7 and 8 may be used in combination.

In the main-pouring step of the liquid accommodation container manufacturing method of this embodiment, the ink L is fed by pressurizing the inner portion of the tank 11a. Thus, when a switching operation, for example, is performed at the time of pouring ink of different types, the ink L in the first piping portion 100 is discharged to the containers 51a and 51b, in such a manner that a waste loss of ink L can be reduced.

The ink L may be poured into the containers 51a and 51b one by one as follows. First, the ink L is poured into the container 51a. Then, when the container 51a is filled with the ink L, the ink L is poured into the container 51b by operating the three-way valves 141a and 141b. Alternatively, the ink L may be poured into the containers 51a and 51b at the same time.

When the ink L is poured into the containers 51a and 51b one by one, as described above, the ink pouring operation may be performed using, at the same time, both the first storage portion 10A and the second storage portion 10B of the storage portion 10. Specifically, the tank 11b of the second storage portion 10B may be depressurized in such a manner that the pressure in the tank 11b is adjusted while the ink L is fed by pressurizing the inner portion of the tank 11a of the first storage portion 10A, in such a manner that the pre-pouring operation of the ink L is performed on the container 51a. In other words, the pre-pouring step of the ink L may be performed in one of the first storage portion 10A and the second storage portion 10B and preparation for the recovery step of the ink L may be performed in the other.

In the pre-pouring step, the pre-pouring operation of the ink and the main pouring operation cannot be performed in a period in which the pressures of the tanks 11a and 11b are increased to a setting value. Furthermore, in the recovery step, the recovery operation of the ink cannot be performed in a period in which the pressure in the tanks 11a and 11b is increased to a setting value. In other words, manufacturing of the liquid accommodation container is delayed in the period necessary for adjusting the pressure in the tanks 11a and 11b.

In contrast, when both the first storage portion 10A and the second storage portion 10B are used at the same time, as in a case described above, the preparation for the recovery step is performed in the tank 11b while the pre-pouring operation is performed on the container 51a. Therefore, the recovery step can be performed using the second storage portion 10B having the tank 11b, immediately after the pre-pouring operation is finished with respect to the container 51a. As a result, it is possible to reduce the period in which manufacturing of the liquid accommodation container is not performed, and thus work efficiency can be improved.

The liquid accommodation container manufacturing method using the manufacturing apparatus 1000 of this embodiment is performed as described above.

According to the liquid accommodation container manufacturing method performed as described above, it is possible to reduce the amount of waste ink while an adequate degasification treatment is reliably performed.

In the this embodiment, one foreign-matter-removing portion 20 is provided in a circulatory system constituted of the storage portion 10, the pouring portion 50, and the first piping portion 100 and the second piping portion 200 which connect the storage portion 10 and the pouring portion 50. However, the configuration is not limited thereto. A plurality of foreign-matter removing portions may be provided in the circulatory system described above and foreign matter in the ink L may be removed at a plurality of positions. The installation position of the foreign-matter removing portion is not limited to the position closer to the storage portion 10 side than the degasification portion 40. The installation position of the foreign-matter removing portion may be in the circulatory system.

In the this embodiment, the storage portion 10 has two storage portions which are the first storage portion 10A and the second storage portion 10B. However, without being limited thereto, the storage portion 10 may have three or more storage portions (in other words, the storage portion 10 may have three or more tanks and metering devices). Alternatively, the storage portion 10 may have only one storage portion (in other words, the storage portion 10 may have a tank and a metering device).

In this embodiment, the pouring portion 50 has two pouring portions which are the first pouring portion 50A and the second pouring portion 50B. However, without being limited thereto, the pouring portion 50 may have three or more pouring portions (in other words, the pouring portion 50 may have three or more containers and metering devices). Alternatively, the pouring portion 50 may have only one pouring portion (in other words, the pouring portion 50 may have a container and a metering device).

In this embodiment, the recovery step is performed using the second piping portion 200. However, the ink L can be recovered using the first piping portion 100.

In this embodiment, the branching portion 30 has the valves 32. However, when pressure losses are the same as in the case of piping portions 130, the branching portion 30 may not have the valves 32. In this case, both the branch pipes 31 and the piping portions 130 correspond to the “pouring-amount control portion” of the invention.

In this embodiment, the pressure losses in the piping portions 130 are the same. However, without being limited thereto, piping portions having different pressure losses may be used. In this case, the operation relating to a valve may be appropriately controlled such that, in the liquid feeding operation, the same amount of liquid is fed to each degasification module 41.

In this embodiment, the inner portion of the tank 11a is pressurized, in such a manner that ink is pressure-fed to the containers 51a and 51b. However, ink may be fed using an additional ink feeding pump, such as a tube pump.

In this embodiment, the inner portion of the tank 11a is depressurized, in such a manner that ink is recovered using the pressure difference between the tank 11a and the containers 51a and 51b. However, ink may be recovered using an additional ink recovery pump.

In this embodiment, the plurality of degasification modules 41 are used. However, even when only one degasification module is used, the liquid feeding operation and the stop operation are alternately repeated and both degasification of ink L and pouring of ink L are performed at the same time as in the case of the manufacturing method of the invention, in such a manner that it is possible to reduce the amount of waste ink while an adequate degasification treatment is reliably performed.

In this embodiment, the bypass piping portion 150 is provided. However, the bypass piping portion 150 may not be provided.

In this embodiment, ink L of 10 ml is fed for each opening/closing operation of the valves 32, in correspondence with the capacity (which is 10 ml) of the pipe conduit 412 of the degasification module 41. However, the amount of fed liquid for each opening/closing operation may not be the same as the capacity of the pipe conduit 412 as long as the amount of fed liquid for each opening/closing operation is equal to or less than the capacity of the pipe conduit 412.

Hereinbefore, the preferable embodiments of the invention are described with reference to the accompanying drawings. However, needless to say, the invention is not intended to be limited by the embodiments. The shapes and the combinations of the components described in the embodiments are examples and can be modified in accordance with design requirements or the like, in various ways within the scope of the invention.

The entire disclosure of Japanese Patent Application No. 2014-063658, filed Mar. 26, 2014 and No. 2014-063659, filed Mar. 26, 2014 are expressly incorporated by reference herein.

What is claimed is:

1. A liquid accommodation container manufacturing method comprising:
pre-pouring liquid from a storage portion for storing the liquid to a container for accommodating the liquid through a first piping portion;
recovering the liquid from the container to the storage portion; and
main-pouring the recovered liquid to the container through the first piping portion,
wherein the first piping portion has a degasification unit which communicates with the first piping portion and performs degasification of the liquid flowing therethrough, and
wherein, in at least a part of the pre-pouring and the main-pouring, a liquid feeding operation in which the liquid of the amount equal to or less than the capacity of the degasification unit is fed and a stop operation in which feeding of the liquid is stopped are alternately repeated and the liquid is subjected to degasification by the degasification unit.

2. The liquid accommodation container manufacturing method according to claim 1,
wherein the degasification unit includes a first degasification module and a second degasification module which are connected in parallel in the first piping portion, and
wherein the pre-pouring and the main-pouring are performed through the first degasification module and the second degasification module.

3. The liquid accommodation container manufacturing method according to claim 2,
wherein, in the pre-pouring and the main-pouring, the liquid feeding operation and the stop operation are alternately repeated with respect to the first degasification module and the second degasification module, the liquid is fed to the second degasification module while feeding of the liquid to the first degasification module stops, and the liquid is subjected to degasification.

4. The liquid accommodation container manufacturing method according to claim 2,
wherein, in the pre-pouring and the main-pouring, the liquid feeding operation and the stop operation are alternately repeated with respect to the first degasification module and the second degasification module, and the liquid is fed to the first degasification module and the second degasification module at the same time.

5. The liquid accommodation container manufacturing method according to claim 1,
wherein the storage portion has a first container and a second container which are connected in parallel in the first piping portion and accommodates the liquid, and
wherein, in the main-pouring, the liquid is poured into the first container and the second container at the same time.

6. The liquid accommodation container manufacturing method according to claim 1,
wherein the storage portion has a first container and a second container which are connected in parallel in the first piping portion and accommodates the liquid, and
wherein, in the main-pouring, the liquid is poured alternately to the first container and the second container.

7. The liquid accommodation container manufacturing method according to claim 1,
wherein, in the main-pouring, the inner portion of the storage portion is pressurized and the liquid is pressure-fed using the pressure difference between the storage portion and the container.

8. The liquid accommodation container manufacturing method according to claim 1,
wherein, in the recovering, the liquid is recovered through a second piping portion connecting the storage portion and the container.

9. The liquid accommodation container manufacturing method according to claim 1,
wherein, in the recovering, the inner portion of the storage portion is depressurized and the liquid is recovered using the pressure difference between the storage portion and the container.

10. The liquid accommodation container manufacturing method according to claim 9,
wherein the storage portion has a first storage portion and a second storage portion which are connected in parallel in the first piping portion, and
wherein, when the pre-pouring or the main-pouring is performed in the first storage portion, the inner portion of the second storage portion is depressurized.

11. The liquid accommodation container manufacturing method according to claim 1,
wherein a bypass piping portion which bypasses the degasification unit is connected to the first piping portion, and
wherein, in the pre-pouring, the liquid is poured from the storage portion to the container through the bypass piping portion.

12. The liquid accommodation container manufacturing method according to claim 11,
wherein, in the pre-pouring, the liquid is poured from the storage portion to the container through the bypass piping portion, then the liquid is poured into the container via the degasification unit, in such a manner that a part of the first piping portion, which is the portion extending from the degasification unit to the container, is filled with the liquid subjected to degasification.

13. The liquid accommodation container manufacturing method according to claim 1,
wherein, in at least the main-pouring, a foreign-matter removing operation is performed to remove foreign matter mixed in the liquid.

14. The liquid accommodation container manufacturing method according to claim 13,
wherein the foreign-matter removing operation is performed further on the storage portion side in the first piping portion than the degasification unit.

15. A liquid accommodation container manufacturing apparatus comprising:
a first piping portion which connects a storage portion for storing liquid and a container for accommodating the liquid;
a first degasification module and a second degasification module which are connected in parallel in a state where the first degasification module and the second degasification module communicate with the first piping portion and which perform degasification of the liquid flowing therethrough, the first degasification module and the second degasification module being provided in a path of the first piping portion; and
a pouring-amount control portion which is disposed further on the storage portion side in the first piping portion than the first degasification module and the second degasification module and controls the amount of liquid poured into the first degasification module and the second degasification module.

16. The liquid accommodation container manufacturing apparatus according to claim 15,
wherein the pouring-amount control portion includes,
a branch pipe which branches the first piping portion into a path directed to the first degasification module and a path directed to the second degasification module,
a valve which is provided in a piping path extending in a portion between the branch pipe and the first degasification module, and
a valve which is provided in a piping path extending in a portion between the branch pipe and the second degasification module.

17. The liquid accommodation container manufacturing apparatus according to claim 15,
wherein the pouring-amount control portion includes,
a branch pipe which branches the first piping portion into a path directed to the first degasification module and a path directed to the second degasification module,
a piping portion which connects the branch pipe and the first degasification module, and
a piping portion which connects the branch pipe and the second degasification module, and
wherein the piping portion connecting the branch pipe and the first degasification module and the piping portion connecting the branch pipe and the second degasification module have the same pressure loss.

18. The liquid accommodation container manufacturing apparatus according to claim 17,
wherein the piping portion connecting the branch pipe and the first degasification module and the piping portion connecting the branch pipe and the second degasification module have the same length.

19. The liquid accommodation container manufacturing apparatus according to claim 18,
wherein the first degasification module and the second degasification module are disposed at positions equidistant from the branch pipe.

20. The liquid accommodation container manufacturing apparatus according to claim 15, further comprising
a foreign-matter removing unit which removes foreign matter mixed in the liquid and is disposed further on the storage portion side in the first piping portion than the pouring-amount control portion.
